(19) United States
(12) Patent Application Publication
(10) Pub. No.: US 2024/0362696 A1
(43) Pub. Date: Oct. 31, 2024

(54) GENERATING ITEM REPLACEMENTS USING MACHINE LEARNING BASED LANGUAGE MODELS

(71) Applicant: Maplebear Inc., San Francisco, CA (US)

(72) Inventors: Shishir Kumar Prasad, Fremont, CA (US); Ahsaas Bajaj, Santa Clara, CA (US)

(21) Appl. No.: 18/643,890

(22) Filed: Apr. 23, 2024

Related U.S. Application Data
(60) Provisional application No. 63/462,187, filed on Apr. 26, 2023.

(51) Int. Cl. G06Q 30/0601; G06F 40/40; G06V 30/10

(52) U.S. Cl. CPC G06Q 30/0629; G06F 40/40; G06V 30/10

(57) ABSTRACT

An online system uses a machine learning based language model, for example, a large language model (LLM) to identify replacement items for an item that may not be available at a store. The online system receives a request for an item and determines that the requested item is not available. The online system identifies a replacement item. If the online system determines that the replacement item has a replacement score below a threshold value indicating a low quality of replacement for the requested item, it uses a machine learning based language model, for example, a large language model to generate an explanation for why the replacement item has a replacement score below the threshold value. The online system sends the explanation to a client device.

### CROSS-REFERENCE TO RELATED APPLICATIONS

This application claims the benefit of U.S. Provisional Application No. 63/462,187, filed on Apr. 26, 2023, which is incorporated by reference herein in its entirety.

### TECHNICAL FIELD

One or more aspects described herein relate generally to machine learning based language models, for example, generating item replacements using machine learning based language models.

### BACKGROUND

An online system allows users to perform transactions associated with items. The items may represent physical entities stored in a physical location. Occasionally an item requested by a user may not be available at a physical location. The requested item may be substituted with a replacement item, for example, a similar item available at the physical location. Depending on the user requirements and the type of replacement item selected, the replacement item may or may not be a suitable replacement. Substituting an item with a replacement item that is not suitable provides a poor user experience for the user requesting the item and may result in delays in completing the transaction, for example, if the user refuses the replacement item.

### SUMMARY

A system (for example, an online system) identifies replacement items for an item requested by a user that is not available, for example, at a store. The system receives a request for an item I1 from a client device of a user and determines that the requested item is not available. The system identifies an item I2 as a replacement for item I1. The system evaluates a measure of the quality of replacement of item I2 for item I1. Based on the evaluation, the system may determine that item I2 is a poor replacement for item I1. If the system determines that item I2 is a poor replacement for item I1, the system generates a prompt requesting an explanation for why item I2 is a poor replacement for item I1. The system provides the prompt to a machine learning based language model, for example, a large language model. The system receives a response to the prompt from the machine learning based language model and sends the response to the user requesting the item I1.

According to one or more embodiments, the system receives an image of the second item, for example, an image captured using a camera phone. The system uses the image to determine whether the second item is a suitable replacement for the first item or for generating the explanation of why the second item is a poor replacement of the first item.

According to one or more embodiments, the prompt sent by the system to the machine learning based language model comprises the image. The machine learning based language model generates the response including the explanation of why the second item is a poor replacement of the first item based on information including the image.

According to one or more embodiments, the system performs optical character recognition on the image to extract a text from the image. The prompt sent to the machine learning based language model includes the text extracted from the image, wherein the machine learning based language model generates the response comprising the explanation of why the second item is a poor replacement of the first item based on information including the text extracted from the image.

According to one or more embodiments, the system processes the image using a machine learning based model, for example, a convolutional neural network, to obtain one or more features of the second item from the image. The prompt sent to the machine learning based language model comprises the features of the second item extracted by the machine learning based model. The machine learning based language model generates the response comprising the explanation of why the second item is a poor replacement of the first item based on information including the one or more features of the second item.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for generating an explanation for why an item is a poor replacement for another item, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

An online system receives a request for an item from a user. If the item is not available, for example, in a store, the online system receives information describing a replacement item for the missing item. The online system determines whether the replacement item is a good or a poor replacement for the missing item. If the online system determines that the replacement item is a poor replacement of the missing item, the online system uses a machine learning based language model, for example, a large language model (LLM) to generate an explanation of why the replacement item is a poor replacement for the missing item. The online system provides the explanation to the user, for example, a user who is acquiring the item from a physical location on behalf of the user requesting the item.

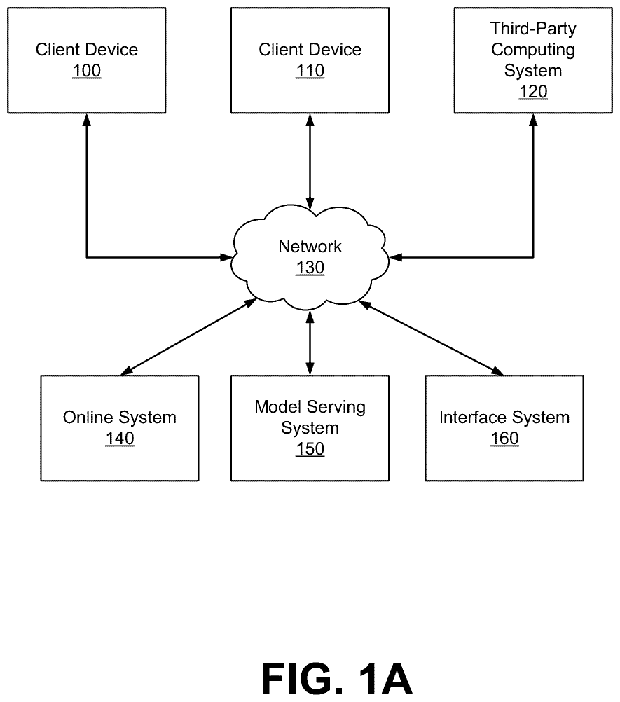

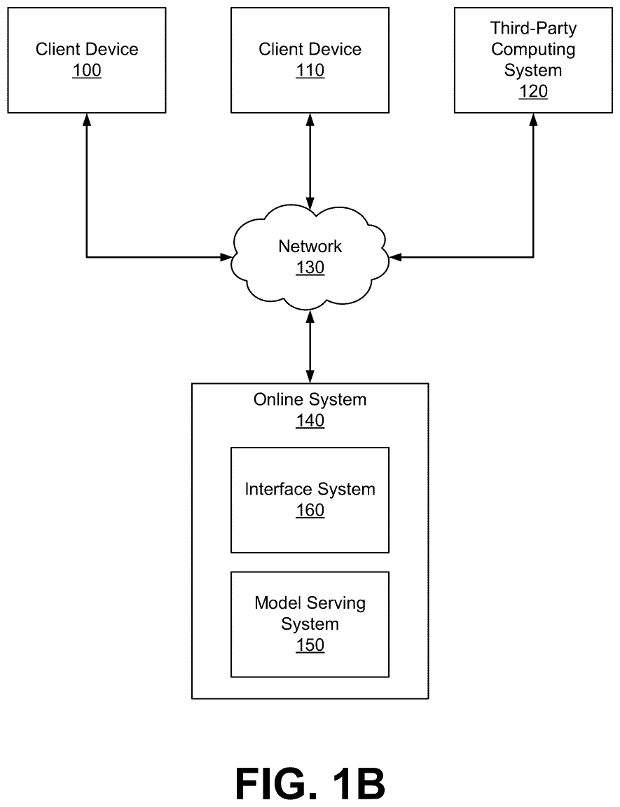

FIG. 1A illustrates an example system environment for an online system 140, in accordance with one or more embodiments. The system environment illustrated in FIG. 1A includes client devices 100, 110, a third-party computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention. Additionally, any number of client devices may interact with the online system 140.

In one or more embodiments, the online system 140 determines replacement items for an item requested by a user, for example, if the requested item is not available. According to one or more embodiments, the online system 140 uses a machine learning based language model to identify replacement items for an item that is not available. The online system 140 evaluates replacement items to determine whether they are good replacements or poor replacements for the item that is not available. If a replacement item is determined to be a poor replacement for an item, the online system 140 determines an explanation describing why the replacement item is a poor replacement of the item that is not available. The online system 140 sends the explanation in real time, for example, as a personal shopper is purchasing items for a user.

The client device 100 is a client device through which a user may interact with another client device 110, the third-party computing system 120, or the online system 140. The client device 100 can be a personal or mobile computing device, such as a smartphone, a tablet, a laptop computer, or desktop computer. In some embodiments, the client device 100 executes a client application that uses an application programming interface (API) to communicate with the online system 140.

A user uses the client device 100 to place an order with the online system 140. An order specifies a set of items to be delivered to the user. An “item”, as used herein, means a good or product that can be provided to the user through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The client device 100 presents a user interface that allows the user to perform actions such as performing searches or placing an order with the online system 140. The ordering interface may be part of a client application operating on the client device 100. The ordering interface allows the user to search for items that are available through the online system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding, or removing items, or adding instructions for items that specify how the item should be collected.

The client device 100 may receive additional content from the online system 140 to present to a user. For example, the client device 100 may receive coupons, recipes, or item suggestions. The client device 100 may present the received additional content to the user as the user uses the client device 100 to place an order (e.g., as part of the ordering interface).

Additionally, the client device 100 includes a communication interface that allows a user to communicate with other users. This communication interface allows the user to input a text-based message to transmit to the client device 110 via the network 130. The client device 110 receives the message from the client device 100 and presents the message to the user of the client device 110. The client device 110 also includes a communication interface that allows the user to communicate with other users. The client device 110 transmits a message provided by the user to the client device 100 via the network 130. In some embodiments, messages sent between the client device 100 and the client device 110 are transmitted through the online system 140. In addition to text messages, the communication interfaces of the client device 100 and the client device 110 may allow the users to communicate through audio or video communications, such as a phone call, a voice-over-IP call, or a video call.

The client device 110 is a client device through which a user may interact with other client devices 100, the third-party computing system 120, or the online system 140. The client device 110 can be a personal or mobile computing device, such as a smartphone, a tablet, a laptop computer, or desktop computer. In some embodiments, the client device 110 executes a client application that uses an application programming interface (API) to communicate with the online system 140.

The third-party computing system 120 is a computing system operated by a third-party, for example, a retailer that interacts with the online system 140. As used herein, a “retailer” is an entity that operates a “retailer location,” which is a store, warehouse, or other building. The third-party computing system 120 stores and provides item data to the online system 140 and may regularly update the online system 140 with updated item data. For example, the third-party computing system 120 provides item data indicating which items are available at a location and the quantities of those items. Additionally, the third-party computing system 120 may transmit updated item data to the online system 140 when an item is no longer available at a location. Additionally, the third-party computing system 120 may provide the online system 140 with updated item prices, sales, or availabilities.

The client devices 100, 110, the third-party computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio date, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 receives a query from a user, for example a natural language query that specifies a high-level intent of the user. The online system 140 uses a machine learning based language model to determine additional information based on the received query. The additional information may specify details of the user's intent in the query or specific attributes based on the query. For example, if the query concerns shopping for a specific occasion such as a birthday or a baby shower, the online system 140 uses the machine learning based language model to identify details of specific items that should be purchased for the occasion. The online system 140 may further obtain details of the items from a catalog associated with a specific retail store. The online system 140 may further obtain details of the items by performing a search using a search engine.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives an external corpus from the online system 140 and builds a structured index over the data using, for example, another machine learning based language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine learning based language model. The interface system 160 can resolve prompt size limitations by generating a structured index of the data and offers data connectors to external data sources as well as provide a flexible connector to the external corpus.

FIG. 1B illustrates an example system environment for an online system 140, in accordance with one or more embodiments. The system environment illustrated in FIG. 1B includes client devices 100, 110, a third-party computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

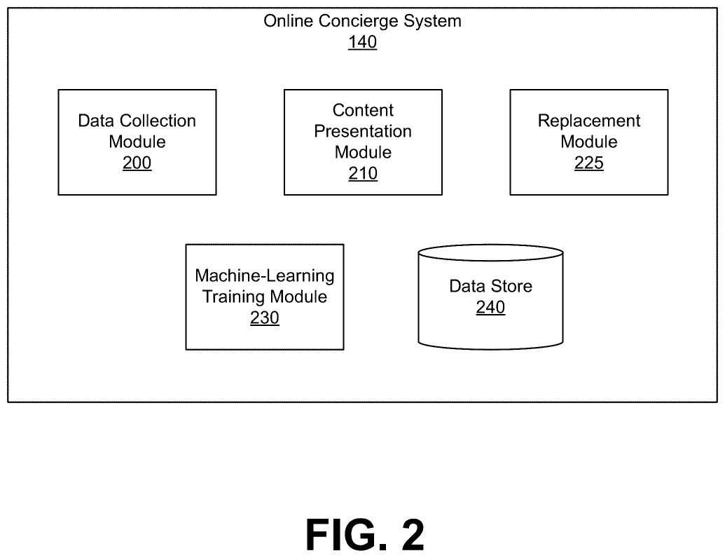

FIG. 2 illustrates an example system architecture for an online system 140, in accordance with some embodiments. The system architecture illustrated in FIG. 2 includes a data collection module 200, a content presentation module 210, a replacement module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, preferences, favorite items, or stored payment instruments. The user data also may include default settings established by the user, such as a default retailer/retailer location, delivery location, or delivery timeframe. The data collection module 200 may collect the user data from sensors on the client device 100 or based on the user's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a user looked for the item but could not find it), the rate at which the item is found, or the popularity of the item. The data collection module 200 may collect item data from the client devices 100, 110.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, when the order was delivered, or a rating that the user gave the delivery of the order. In some embodiments, the order data includes user data for users associated with the order, such as user data for a user who placed the order.

The content presentation module 210 selects content for presentation to a user. For example, the content presentation module 210 selects which items to present to a user while the user is placing an order. The content presentation module 210 generates and transmits the ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine learning models and may be stored in the data store 240.

In some embodiments, the content presentation module 210 scores items based on a search query received from the client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a user based on whether the predicted availability of the item exceeds a threshold.

The replacement module 225 identifies replacements for items that a user is interested in purchasing, for example, replacements for items that are not available in a store. The replacement module 225 may recommend one or more replacement items for a particular item that is not available. The replacement module 225 also determines a quality of replacement offered by an item for another item. If an item is determined to be a poor replacement for another item, the replacement module 225 determines an explanation as to why the item is a poor replacement for the other item.

In one or more embodiments, the online system 140 may additionally fine-tune parameters of the machine learning based language model using multiple instances of training data. An instance in the training data may include strings or sentences obtained by concatenating inputs and expected outputs of the machine learning based language model. For example, the training data may comprise natural language questions received from users with lists of items, item types, or categories of items associated with the natural language question. The training data may comprise natural language questions concatenated with contextual data describing users further concatenated with lists of items, item types, or categories of items associated with the natural language question. Contextual data describing users includes user profile information of the user, one or more previous interactions of the user with the online system, items previously selected by the user using the online system, browsing history of the user while interacting with the online system, and so on. The machine learning based language model receives an input sentence with missing tokens from the output portion of the input sentence and predicts the missing tokens. A loss function is computed by aggregating loss values obtained from the predicted tokens and the known tokens of the output portion of the sentences provided as training data. The errors obtained from the loss function are backpropagated to update parameters of the machine-learned model.

According to one or more embodiments, training data is generated from historical data. For example, items or item types associated with specific holidays or festivals are obtained by analyzing the items with high frequency of occurrence in transactions performed within a threshold time/days of the specific holidays or festivals. The training data may also be obtained from experts or by crowdsourcing. For example, users may specify the types of items or item types relevant to occasions such as birthdays, weddings, baby showers, housewarming, and so on.

The machine learning training module 230 trains machine learning models used by the online system 140. For example, the machine learning training module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include user data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

According to one or more embodiments, the online system 140 provides the information associating contextual information with items or item types to the interface system 160. For example, the sentences or textual data that associates various event types (e.g., birthdays, weddings, and so on) or festivals (Christmas, thanksgiving, and so on) with of items or item types frequently used for the corresponding events or festivals by users is provided to the interface system 160. The interface system 160 builds a structured index using this data, for example, another machine-learned language model or heuristics. The structured index comprises data structures that store information obtained from external sources, for example, a corpus of unstructured text representing the associations described herein. Examples of such an index include GPT Index and LlamaIndex. The index allows the system to connect the corpus of information with a machine-learned language model so that the answers to a prompt are based on the knowledge of the trained machine-learned language model as well as the information stored in the corpus. Accordingly, in the system as disclosed the answers to prompts requesting attributes or items/item types associated with a search query are based on knowledge of the trained machine-learned language model as well as the information stored in the corpus or user comments.

The data store 240 stores data used by the online system 140. For example, the data store 240 stores user data, item data, and order data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine learning training module 230 may further train parameters of the machine-learned model based on data specific to the online system 140 stored in the data store 240. As an example, the machine learning training module 230 may obtain a pre-trained transformer language model and further fine tune the parameters of the transformer model using training data stored in the data store 240. The machine learning training module 230 may provide the model to the model serving system 150 for deployment.

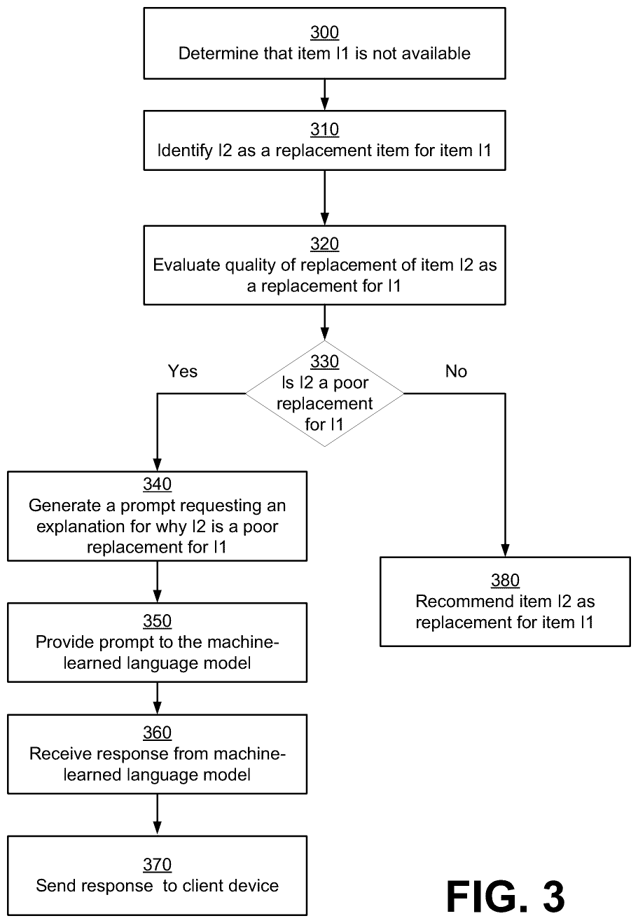

FIG. 3 is a flowchart for generating an explanation for why an item is a poor replacement for another item, in accordance with one or more embodiments. Alternative embodiments may include more, fewer, or different steps from those illustrated in FIG. 3, and the steps may be performed in a different order from that illustrated in FIG. 3. These steps may be performed by a system (e.g., an online system such as the online system 140). Additionally, each of these steps may be performed automatically by the online system without human intervention.

The online system receives a list of items requested by a user U1. Another user U2, for example, a personal shopper may attempt to obtain the items from a store, for example, a physical store. The user U2 may determine that the item I1 is not available at the store and indicate to the online system that the item I1 is not available. Accordingly, the online system determines 300 that the item I1 is not available, for example, by receiving an indication from the client device of the user U2 that the item I1 is not available at the store. In alternative embodiments, the online system may obtain the indication that the item is not available by invoking an API (application programing interface) associated with the physical location where the user U2 is acquiring the item I2, for example, a physical store where the user U2 may be shopping on behalf of the user U1.

The online system identifies 310 an item I2 as a replacement for the item I1. The online system may receive information identifying the item I2 as a replacement for the item I1 from the client device of the user U2. According to one or more embodiments, the online system automatically determines that item I2 is a replacement for item I1. For example, the online system may use a machine learning model trained to compare items and determine whether an item is a good replacement for another item. As another example, the online system may generate a prompt P1 for a machine learning based language model requesting one or more replacement items for item I1 and send the prompt P1 to the machine learning based language model. An example prompt is “what are various replacements for item I1?”

The online system receives a response R1 to the prompt P1 from the machine learning based language model. The response R2 includes one or more replacement items for item I1. The prompt P1 may specify a specific format for the list of replacement items, for example, an enumerated list or a list specified using JSON (JavaScript Object Notation) format. The online system extracts the replacement items from the response.

The online system evaluates 320 the quality of replacement of item I2 as a replacement for item I1. Accordingly, the online system determines 330 whether item I2 is a good replacement or a poor replacement for item I1. According to one or more embodiments, the online system uses a machine learning based model trained to predict a quality of replacement offered by an item for another item. The machine learning based model may be trained using labeled data and outputs a score, for example, on a predefined scale such as scale of 1 to 10 numbers indicating the quality of replacement offered by an item for another item.

According to one or more embodiments, the online system uses the machine learning based language model for determining whether an item I2 identified as a replacement item for item I1 is a good replacement item or a poor replacement item. The online system generates 340 a prompt P2 requesting an evaluation of the second item as a replacement for the first item. For example, the prompt P2 may be “Is item I2 a good replacement for item I1?” The online system provides 350 the prompt P2 to the machine learning based language model. The online system receives 360 a response R2 to the prompt P2 from the machine learning based language model. The online system determines whether the item I2 is a good replacement for the item I1 based on the response R2. According to one or more embodiments, the online system specifies in the prompt P2 that the machine learning based language model should return a score indicating the quality of replacement provided by item I2 for item I1. The online system compares the received score value with a threshold value to determine whether the item I2 is a good replacement item or a poor replacement item. According to an embodiment, the system determines a replacement score for a replacement item I2 indicating whether the replacement item I2 is a poor replacement of the item I1 or a good replacement of the item I1. For example, if the replacement score of the replacement item I2 is less than a threshold value, the replacement item is considered as being a poor replacement of item I1 and if the replacement score of the replacement item is greater than the threshold value, the replacement item I2 is considered as a good replacement of item I1.

If the online system determines that item I2 is a poor replacement for item I1, the online system may repeat steps 340, 350, 360, and 370 until a suitable replacement item is found. For example, the user U2 may identify additional items and the online system determines whether the additional items are suitable replacements. If the online system determines that the additional item is not a suitable replacement item, the online system generates 340 a prompt P3 requesting an explanation for why any additional item is a poor replacement for the item requested by the user. An example prompt P3 is “why is item I2 a poor replacement for item I1.” The online system provides 350 the prompt P3 to the machine learning based language model. The online system receives 360 a response R3 to the prompt from the machine learning based language model. The response R3 includes an explanation of why the additional item is a poor replacement of the item requested by the user. The online system sends 370 the response R3 to the client device of the user U2. Accordingly, the online system may flag that the additional item is not a good replacement for the item requested by the user and may provide an explanation describing why the additional item is a poor replacement for the item requested by the user. Providing the explanation in real-time, i.e., while the user U2 is handling a request from user U1 allows the user U2 to identify better replacements as well as avoid recommending poor replacements.

Returning to step 330, if the online system determines that the item I2 is a good replacement for item I1, the online system performs step 380. Accordingly, the online system recommends the items I2 as a replacement for item I1.

According to one or more embodiments, the online system may check availability of each of the items in the list of replacement items to determine whether the item is available, before recommending the item to the user. Such item availability information may, e.g., be retrieved from one or more catalog systems and/or databases. This way the online system avoids recommending items that are not available again. The ability to evaluate replacement items and provide explanations providing reasoning for the evaluation reduces the number of interactions between the user U1 requesting the item and the user U2 acquiring the items from a physical location, thereby saving resources including user time as well as computational resources such as network bandwidth and processing resources due to reduced interactions between client devices of different users and the online system.

### Multi-Modal Processing of Replacement Items

According to one or more embodiments, the system receives an image of a candidate replacement item and uses the image to determine whether the candidate replacement item is suitable as a replacement item or a poor choice as a replacement item. If the candidate item is a poor choice as a replacement item. the online system may use the image to generate the explanation of why the candidate item is a poor replacement of the first item.

As an example, the online system may receive a request for particular item I1 from a user U1. A user U2 may look for the item at a physical location, for example a store. If the user U2 does not find the item I1, the user U2 may identify a replacement item I2. The user U2 takes an image of the item I2, for example, using a camera phone and provides the image to the online system. At least a part of the processing of the image may be performed at the client device of the user U2.

According to one or more embodiments, the machine learning based language model is a multi-modal language model that is trained to process different types of input including text input as well as image input. Accordingly, the online system sends a prompt to the machine learning based language model that includes the image along with additional information such as the original item requested by the user, any relevant information describing the user, for example, any user preferences or restrictions. The machine learning based language model generates the response including the explanation of why the second item is a poor replacement of the first item based on information received in the prompt including the image.

According to one or more embodiments, the online system or the client device performs optical character recognition on the image to extract a text from the image. The text may provide information describing the candidate replacement item, for example, the name of the item, nutrition information or items, any user restrictions for which the candidate replacement item should not be used, and so on. For example, the candidate replacement item may be a food item that lists dietary restrictions on a label of the candidate replacement item. The online system sends the prompt to the machine learning based language model including the text extracted from the image. The machine learning based language model uses the text for determining whether the candidate replacement item is a suitable replacement for the item and for the particular user based on the user information. The machine learning based language model may generate a response including an explanation of why the candidate replacement item is a poor replacement of the item requested by the user based on information including the text extracted from the image.

According to one or more embodiments, the online system includes a machine learning based model trained to extract information from an image. For example, the machine learning based model may be a neural network such as a convolutional neural network trained to process specific types of items and determine features of the items from the image. The online system processes the image using the machine learning based model to obtain one or more features of the candidate replacement item from the image. The machine learning based model may be provided to the client device, for example, a mobile phone used to capture the image of the candidate replacement item and may extract the features of the candidate replacement item at the client device so that the extracted features are provided to the online system instead of the image of the candidate replacement item. This is more efficient in terms of network bandwidth since less information needs to be transmitted over the network. The online system sends the prompt to the machine learning based language model including the features of the candidate replacement item extracted from the image. The machine learning based language model uses the features of the candidate replacement item for determining whether the candidate replacement item is a suitable replacement for the item and for the particular user based on the user information. The machine learning based language model may generate a response including an explanation of why the candidate replacement item is a poor replacement of the item requested by the user based on information including the features of the candidate replacement item extracted from the image.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable storage medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include, applying the machine learning model to a training example, comparing an output of the machine learning model to the label associated with the training example, and updating weights associated for the machine learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present), and B is false (or not present), A is false (or not present), and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present), and C is false (or not present). Similarly, as another not-limiting example, the condition “A, B, or C” is satisfied when A is true (or present), and B and C are false (or not present).

What is claimed is:

1. A method comprising:
at a computer system comprising a processor and a computer-readable storage medium:
receiving a request for a first item;
identifying that the first item is not available;
identifying a second item as a replacement for the first item;
identifying a replacement score for the second item as the replacement for the first item;
identifying that the second item has a replacement score below a threshold value, indicating a below threshold quality of replacement;
generating a prompt requesting an explanation of a reason that the second item has the replacement score below the threshold value;
providing the prompt to a machine learning based language model;
receiving a response to the prompt from the machine learning based language model, the response comprising an explanation of why the second item has the replacement score below the threshold value; and
sending the response to a client device of a user.

2. The method of claim 1, further comprising:
receiving an image of the second item; and
using the image to identify the explanation of why the second item has the replacement score below the threshold value.

3. The method of claim 2, wherein the prompt sent to the machine learning based language model comprises the image, wherein the machine learning based language model generates the response comprising the explanation of why the second item has the replacement score below the threshold value based on information including the image.

4. The method of claim 2, further comprising:
performing optical character recognition on the image to extract a text from the image;
wherein the prompt sent to the machine learning based language model comprises the text extracted from the image, wherein the machine learning based language model generates the response comprising the explanation of why the second item has the replacement score below the threshold value based on information including the text extracted from the image.

5. The method of claim 2, further comprising:
processing the image using a machine learning based model to obtain one or more features of the second item from the image;
wherein the prompt sent to the machine learning based language model comprises the one or more features of the second item, wherein the machine learning based language model generates the response comprising the explanation of why the second item has the replacement score below the threshold value based on information including the one or more features of the second item.

6. The method of claim 1, wherein the prompt is a first prompt, and the response is a first response, the method further comprising:
generating a second prompt requesting one or more possible replacement items for the first item; and
providing the prompt to the machine learning based language model;
receiving a second response to the second prompt from the machine learning based language model; and
extracting one or more replacement items from the second response.

7. The method of claim 1, wherein the prompt is a first prompt, and the response is a first response, the method further comprising:
generating a second prompt requesting an evaluation of the second item as a replacement for the first item;
providing the prompt to the machine learning based language model;
receiving a second response to the second prompt from the machine learning based language model; and
identifying whether the second item is a good replacement for the first item based on the second response.

8. The method of claim 1, wherein the response is a first response, the replacement score is a first replacement score, the method further comprising:
identifying a third item as a replacement for the first item;
identifying a second replacement score for the third item as the replacement for the first item;
identifying that the third item has the second replacement score above the threshold value, indicating an above threshold quality of replacement; and
sending a second response to a client device of a user indicating the third item as the replacement item for the first item.

9. A non-transitory computer readable storage medium, storing instructions that when executed by one or more computer processors cause the one or more computer processors to perform steps comprising:
receiving a request for a first item;
identifying that the first item is not available;
identifying a second item as a replacement for the first item;
identifying a replacement score for the second item as the replacement for the first item;
identifying that the second item has a replacement score below a threshold value, indicating a below threshold quality of replacement;
generating a prompt requesting an explanation of a reason that the second item has the replacement score below the threshold value;
providing the prompt to a machine learning based language model;
receiving a response to the prompt from the machine learning based language model, the response comprising an explanation of why the second item has the replacement score below the threshold value; and
sending the response to a client device of a user.

10. The non-transitory computer readable storage medium of claim 9, wherein the instructions further cause the one or more computer processors to performs steps comprising:
receiving an image of the second item; and
using the image to identify the explanation of why the second item has the replacement score below the threshold value.

11. The non-transitory computer readable storage medium of claim 10, wherein the prompt sent to the machine learning based language model comprises the image, wherein the machine learning based language model generates the response comprising the explanation of why the second item has the replacement score below the threshold value based on information including the image.

12. The non-transitory computer readable storage medium of claim 10, wherein the instructions further cause the one or more computer processors to performs steps comprising:
performing optical character recognition on the image to extract a text from the image;
wherein the prompt sent to the machine learning based language model comprises the text extracted from the image, wherein the machine learning based language model generates the response comprising the explanation of why the second item has the replacement score below the threshold value based on information including the text extracted from the image.

13. The non-transitory computer readable storage medium of claim 10, wherein the instructions further cause the one or more computer processors to performs steps comprising:
processing the image using a machine learning based model to obtain one or more features of the second item from the image;
wherein the prompt sent to the machine learning based language model comprises the one or more features of the second item, wherein the machine learning based language model generates the response comprising the explanation of why the second item has the replacement score below the threshold value based on information including the one or more features of the second item.

14. The non-transitory computer readable storage medium of claim 9, wherein the prompt is a first prompt, and the response is a first response, wherein the instructions further cause the one or more computer processors to performs steps comprising:
generating a second prompt requesting one or more possible replacement items for the first item; and
providing the prompt to the machine learning based language model;
receiving a second response to the second prompt from the machine learning based language model; and
extracting one or more replacement items from the second response.

15. The non-transitory computer readable storage medium of claim 9, wherein the prompt is a first prompt, and the response is a first response, wherein the instructions further cause the one or more computer processors to performs steps comprising:
generating a second prompt requesting an evaluation of the second item as a replacement for the first item;
providing the prompt to the machine learning based language model;
receiving a second response to the second prompt from the machine learning based language model; and
identifying whether the second item is a good replacement for the first item based on the second response.

16. The non-transitory computer readable storage medium of claim 9, wherein the response is a first response, the replacement score is a first replacement score, the method further comprising:
identifying a third item as a replacement for the first item;
identifying a second replacement score for the third item as the replacement for the first item;
identifying that the third item has the second replacement score above the threshold value, indicating an above threshold quality of replacement; and
sending a second response to a client device of a user indicating the third item as the replacement item for the first item.

17. A computer system comprising:
one or more computer processors; and
a non-transitory computer readable storage medium storing instructions that when executed by one or more computer processors cause the one or more computer processors to perform steps comprising:
receiving a request for a first item;
identifying that the first item is not available;
identifying a second item as a replacement for the first item;
identifying a replacement score for the second item as the replacement for the first item;
identifying that the second item has a replacement score below a threshold value, indicating a below threshold quality of replacement;
generating a prompt requesting an explanation of a reason that the second item has the replacement score below the threshold value;
providing the prompt to a machine learning based language model;
receiving a response to the prompt from the machine learning based language model, the response comprising an explanation of why the second item has the replacement score below the threshold value; and
sending the response to a client device of a user.

18. The computer system of claim 17, wherein the prompt is a first prompt, and the response is a first response wherein the instructions further cause the one or more computer processors to performs steps comprising:
generating a second prompt requesting one or more possible replacement items for the first item; and
providing the prompt to the machine learning based language model;
receiving a second response to the second prompt from the machine learning based language model; and
extracting one or more replacement items from the second response.

19. The computer system of claim 17, wherein the prompt is a first prompt, and the response is a first response, wherein the instructions further cause the one or more computer processors to performs steps comprising:
generating a second prompt requesting an evaluation of the second item as a replacement for the first item;
providing the prompt to the machine learning based language model;
receiving a second response to the second prompt from the machine learning based language model; and
identifying whether the second item is a good replacement for the first item based on the second response.

20. The computer system of claim 17, wherein the response is a first response, the replacement score is a first replacement score, the method further comprising:
identifying a third item as a replacement for the first item;
identifying a second replacement score for the third item as the replacement for the first item;
identifying that the third item has the second replacement score above the threshold value, indicating an above threshold quality of replacement; and
sending a second response to a client device of a user indicating the third item as the replacement item for the first item.
